(19) United States
(12) Patent Application Publication
(10) Pub. No.: US 2014/0223653 A1
(43) Pub. Date: Aug. 14, 2014

(54) Plumbing Tool and Method

(71) Applicant: Wendell E. Miller, Warsaw, IN (US)

(72) Inventor: Wendell E. Miller, Warsaw, IN (US)

(21) Appl. No.: 14/193,104

(22) Filed: Feb. 28, 2014

Related U.S. Application Data
(63) Continuation-in-part of application No. 13/585,361, filed on Aug. 14, 2012.
(60) Provisional application No. 61/772,049, filed on Mar. 4, 2013.

(51) Int. Cl. B08B 9/04; E03D 9/00

(52) U.S. Cl. CPC B08B 9/04; E03D 9/00
USPC 4/255.01

(57) ABSTRACT

Plumbing tools (50, 110, 140, 180, 220, 260, 290, 340, and 400) comprise a ramrod (10, 90, 112, 188, 222, or 402) with longitudinal portions (188 and 190, 130, or 142 and 144) that include unidirectional and/or bidirectional stiffening, or three longitudinal portions (142, 140, and 144 or 188, 190, and 192) that include unidirectional and/or bidirectional stiffening. The method includes manual ramming (FIGS. 7, 10, 13, 17, and 26), slide hammering (FIG. 30), and power-impact ramming (FIGS. 31-33). Power-impact ramming (FIGS. 31-33) optionally includes a rotary-to-impact converter (FIG. 33). The method includes flexibly threading a ramrod (10, 90, 112, 142, 188, 226, or 402) into a passageway (16), ramming one end, elastically transferring ramming energy, and impacting a blockage (30). Optionally the method includes distributing the plumbing tool (110, 140, or 180) as promotional merchandise.

### CROSS-REFERENCES TO RELATED APPLICATIONS

This patent application is a Continuation-in-Part of U.S. patent application Ser. No. 13/585,361, filed on Aug. 14, 2012, and claims priority to Provisional Patent Application Ser. No. 61/772/049 filed on Mar. 4, 2013.

### STATEMENT RE FEDERALLY SPONSORED RESEARCH OR DEVELOPMENT

Not Applicable

### PARTIES TO A JOINT RESEARCH AGREEMENT

Not Applicable

### INCORPORATION OF COMPACT DISK MATERIAL

Not Applicable

### REFERENCE TO SEQUENCE LISTING

Not Applicable

### BACKGROUND OF THE INVENTION

1. Field of the Invention

The present invention relates generally to plumbing tools and methods for clearing blockages from plumbing passageways such as curved discharge passageways in toilet stools. More particularly, the present invention pertains to plumbing tools and methods for manually, slide-hammer, and or power-impact ramming blockages through curved discharge passageways of toilet stools and/or through drain pipes with or without rotation.

Power impact ramming embodiments include electro-mechanical devices such as auto-hammers, saber saws, electric drills, hammer drills, pneumatic power devices, rotation-to-impact converters, or any other suitable rotating or reciprocating power device for power ramming.

The plumbing tools include a ramrod which optionally is in the form of an extruded plastic strip, a coiled steel spring, a metal insert extruded in a plastic strip, or a plurality of stacked steel ribbons extruded in a plastic strip.

Various embodiments include bidirectional stiffening and/or unidirectional stiffening, and stiffening comprises increasing a section modulus. One embodiment optionally includes measurements in centimeters and/or inches, and an advertising message may be included when used as promotional merchandise.

2. Description of the Related Art

The convenience of indoor plumbing is taken for granted until a toilet stool or drain pipe becomes plugged, then household convenience is transformed into a minor household emergency. No one in the family wants to revert to more primitive sanitary facilities, even temporarily. Instead, everyone in the household wants normal function and use of the stool or drain line restored immediately.

Toilet stools commonly include a curved discharge passageway that bends upwardly and downwardly around transverse axes to form a trap before exiting into the sewer. The trap holds a small quantity of water, before and after flushing, so that sewer gases are blocked. Commonly, the curved discharge passageway is sized to pass a two inch (50.8 mm) ball, although more expensive toilet stools sometimes have larger discharge passageways.

The two inch (50.8 mm) curved discharge passageway of the toilet stool commonly connects to a four inch (101 mm) sewer pipe, although at times only three inch (76.2 mm) sewer pipes are used. Either way, it is obvious that, if blockage is to occur, it is more likely to occur in the two inch (50.8 mm) discharge passageway than in a three inch (76.2 mm) or four inch (101 mm) sewer pipe. Therefore, nearly all toilet stool blockages occur in a passageway that is about 28 inches (71.1 cm) long.

The most common apparatus for opening clogged passageways in toilet stools has been a flexible plunger with a wooden handle that is used to force air and/or water into the clogged passageway. A modern version is taught by Tash in U.S. Pat. No. 6,374,427 wherein a bellows and handle are molded integrally.

The use of conventional toilet plungers produces uncertain, unreliable, and mixed results. One problem is in the shape of the opening discharge passageway where it connects to the bowl of the stool. Commonly, shapes of these openings deviate somewhat from circular, so that a reliable seal between the plunger and the stool bowl is not achieved. As a result, a few plunges of a stool plunger may clear an obstruction in a curved discharge passageway; a few hundred may not.

While plumbing snakes are effective in opening sewer lines, they have not commonly been used in toilet stools because of danger to porcelain surfaces. To overcome the problem of possible damage to porcelain surfaces when using a conventional plumbing snake to clear blockages in toilet stools, Rodriguez, in U.S. Pat. No. 5,230,116, teaches an anti-scratch snake. His anti-scratch snake includes a protective tube, with a metal snake inserted and rotated inside the protective tube.

While plumbing snakes are quite effective in opening plugged sewer lines, they are not particularly effective in removing blockages from toilet stools, because blockages in toilet stools are usually caused by children placing too much paper in the toilet stool. Auguring through a soggy mass of wet paper is not an especially effective method for removing the blockage, nor is auguring through a wadded mass of wet paper particularly effective for reestablishing the fluid flow capacity that is necessary for effective flushing.

Palmer, in U.S. Pat. No. 4,025,982, teaches a plastic device with different size scrubbing brushes on opposite ends, and a plurality of ball-like enlargements to guide the device along the curved discharge passageway of a toilet stool, whereby back and forth movement scrubs the curved discharge passageway.

While blockages in toilet stools in homes are most often caused by children acting in innocence, blockages in public restrooms are all too often caused by teens and adults, who indifferently or maliciously place material or objects in toilet stools that cause blockages. High janitorial and plumbing costs demand that equipment used in public restrooms yield prompt and effective results. The wide variety of complex and expensive devices that are continually being patented for stool blockage removal attests to this truth.

Prestia, in U.S. Pat. No. 7,877,821, teaches a portable compressed air device. Similarly, Flamand, in Published Application No. 20100132102 teaches a high pressure flush of water or suction. The downside of using high pressures is that the wax seal may be damaged, leakage occurs between the stool and the sewer pipe, and it becomes necessary to reset the stool with a new wax ring.

Whereas methods for clearing blockages in toilet tools commonly have involved using pressurized water, pressurized air, a vacuum, a sheathed auger, a mop, or a plunger to force water and/or air against a stool blockage, the present invention provides a plumbing that impactly rams blockages through the curved discharge passageways with or without rotation.

Whereas methods for clearing blockages in plumbing drain pipes commonly have involved rotating a spring coil device called a “snake,” the present device provides a plumbing tool that impactly rams blockages through plumbing drain pipes with or without rotation necessarily accompanying ramming.

More particularly, a first end of a plumbing ramrod is flexibly or elastically threaded in the curved discharge passageway, the other end is manually, slide hammer, or power rammed, and the first end impacts the blockage.

### BRIEF SUMMARY OF THE INVENTION

The present invention provides plumbing tools and methods for manually or power-impact ramming blockages through curved discharge passageways of toilet stools and through drain pipes.

The method of the present invention comprises: flexibly or elastically threading a plumbing ramrod into a curved discharge passageway of a toilet stool proximal to a blockage, or into the discharge passageway of a drain pipe proximal to a blockage; ramming the ramrod toward the blockage; and impactly ramming the blockage through the discharge passageway or the drain pipe.

In embodiments of greatest simplicity and economy, plumbing ramrods of the plumbing tools are plastic extrusions with flat, and/or curved, surface areas that are suitable for advertising, and that can be manufactured so economically that they can be used as promotional merchandise, and therefore have tremendous and long enduring market potential.

In embodiments used as promotional merchandise, the plumbing ramrods resemble a yardstick in cross-section, are uniform in cross sectional area for a portion of their lengths, and have a thickness smaller than their width. If dimension inscriptions are included, in addition to being used as a plumbing tool, these plumbing tools can also be used as yardsticks.

Yardsticks, with advertising messages imprinted thereon, have been used as promotional merchandise, and have been given to potential or actual customers, for about one-hundred years. In like manner, the simplicity, low cost, and yardstick-like advertising surfaces of ramrods of the aforesaid simplest embodiments make them ideal for use as promotional merchandise, whether or not measuring increments are included along with an advertising message.

While some embodiments of the present invention are similar to yardsticks, they are entirely different both mechanically and functionally. Whereas yardsticks are relatively stiff, at least a longitudinal portion of the plumbing ramrods of the present invention are flexible.

Whereas yardsticks are used as measuring devices, the plumbing ramrods of the present invention are used for elastically threading into curved discharge passageways of toilet stools, and for impactingly ramming blockages through curved discharge passageways of toilet stools and/or through passageways of plumbing drain pipes.

Even when plungers fail, blockages in toilet stools ordinarily can be rammed through the curved discharge passageways and into the sewer line, or through discharge passageways of drain pipes, using even the more economical embodiments shown herein, by simply ramming the plumbing ramrod inwardly once or a few times.

All plumbing tools of the present invention include a plumbing ramrod, such as an extruded plastic strip, a coiled wire spring, or a stack of steel ribbons that can be flexibly or elastically threaded through the intended plumbing passage, such as the curved discharge passageway of a toilet stool. As such, all of the ramrods have compressive elasticity and bend flexibly and/or elastically.

Most embodiments include either a guide sleeve or a longitudinal portion with stiffening to prevent unwanted buckling. Whether bidirectional stiffened or unidirectional stiffened, or both, and whether stiffening comprises a sleeve, a doubled portion, a folded portion, or laminated steel ribbons, stiffening comprises increasing a section modulus. Some embodiments have two longitudinal portions with differing section modulus and stiffness, others have three.

Various embodiments of the present invention are manually rammed, slide-hammer rammed, or power rammed. Power ramming preferably uses an electrical power device, such as an electric drill, a hammer drill, an electric hammer, or a saber saw. Any suitable power device may be used.

For homeowners who own an electric drill, a preferred embodiment includes a plumbing ramrod and a rotary-to-impact converter. When a shaft of the rotary-to-impact converter is chucked into any electric drill, the combination becomes a power-impacting plumbing tool. The power-impacting plumbing tool provides repetitive ramming impacts in response to a rotary input.

Utility of the embodiments of the present invention is in their ability to elastically impactly ram blockages through curved discharge passageways quickly, reliably, and without danger of damage to porcelain surfaces and wax seals; and/or to impactly ram blockages through discharge passageways in drain pipes quickly and reliably.

A first object of the present invention is to provide a plumbing tool and method for clearing blockages in passageways of plumbing pipes quickly and reliably.

A second object of the present invention is to provide a plumbing tool and method for clearing blockages in curved discharge passageways with minimum effort, without danger of damaging porcelain surfaces, and without danger of damaging the wax seal between the stool and the sewer pipe.

A third object of the present invention is to provide a plumbing tool with an ramrod that has sufficient flexibility for flexibly or elastically threading though a curved discharge passageway and that has compressive elasticity.

A fourth object of the present invention is to provide a plumbing tool with an ramrod that comprises a plastic extrusion, a spring steel coiled spring, a metallic insert extruded in a plastic sheath, or a stack of spring steel ribbons extruded in a plastic sheath.

A fifth object of the present invention is to provide a plumbing tool with a first longitudinal portion with flexibility sufficient for threading through curved discharge passageways of toilet stools, and a second longitudinal portion with stiffening which alternately comprises a guide sleeve, an increased section modulus, a selectively-increased section modulus, unidirectional stiffening, or bidirectional stiffening.

A sixth object of the present invention is to provide a method for clearing blockages in toilet stools in which ramming one end elastically transmits energy to another end.

A seventh object of the present invention is to power-ram a first end of a plumbing tool and both repetitively and elastically impact blockages.

An eighth object of the present invention is to provide a plumbing tool and method for clearing blockages in discharge passageways of toilet stools and/or plumbing pipes in which impactly ramming one end of a plumbing ramrod elastically transmits energy to a blockage in a discharge passageway.

A ninth object of the present invention is to provide a plumbing tool and method for clearing blockages in discharge passageways of toilet stools and/or plumbing pipes in which impactly ramming one end of a plumbing ramrod elastically transmits energy past friction contacts in discharge passageways, thereby essentially preventing friction from reducing the effectiveness of impact ramming.

A tenth object of the present invention is to provide a plumbing tool and method for clearing blockages in discharge passageways of toilet stools and/or plumbing pipes in which impactly ramming one end of a plumbing ramrod clears blockages by rattling the plumbing ramrod through discharge passageways without developing full serpentine contact with the discharge passageway, thereby essentially obviating friction.

An eleventh object of the present invention is to provide power-impacting plumbing tools which comprises a plumbing ramrod and power device, such as a power hammer or other power-reciprocating device.

A twelfth object of the present invention is to provide power-impacting plumbing tools which comprises a plumbing ramrod, a rotary-to-reciprocating converter, and an electric drill.

A thirteenth object of the present invention is to provide power-impacting plumbing tools in which portions of the stroke of power impact ramming are selectively applied to the plumbing ramrod.

A fourteenth object of the present invention is to provide a plumbing tool which comprises a plumbing ramrod with a stiffening sleeve, unidirectional stiffening, a doubled portion, a folded portion, spaced-apart longitudinal portions, stacked ribbons, stacked ribbons that are securely attached at a longitudinal location, and/or stacked ribbons with means for restraining longitudinal movement between adjacent ones of the steel ribbons.

A fifteenth object of the present invention is to provide a plumbing tool that is so economical to manufacture that it may be used as promotional merchandise.

In a first aspect the present invention, a method comprises: flexibly threading a plumbing ramrod into a plumbing passageway proximal to a blockage; ramming one end of said ramrod; and impacting said blockage in response to said ramming step.

In a second aspect the present invention, a method comprises: flexibly threading a plumbing ramrod into a curved discharge passageway of a toilet stool proximal to a blockage; ramming one end of said ramrod; and impacting said blockage in response to said ramming step.

In a third aspect of the present invention, a plumbing tool comprises: an elongated plumbing ramrod with a first longitudinal portion that has elastic flexibility sufficient for threading into curved discharge passageways of toilet stools; and means for stiffening a second longitudinal portion.

### BRIEF DESCRIPTION OF THE SEVERAL VIEWS OF THE DRAWINGS

FIG. 1 is a cross-sectioned elevation of a toilet stool showing a plumbing ramrod, in the form of an extruded plastic strip, flexibly or elastically threaded through the curved discharge passageway;

FIG. 2 is a cross-sectioned elevation of the toilet stool of FIG. 1, taken substantially the same as shown in FIG. 1, showing both serpentine bending and unwanted buckling of the plumbing ramrod of FIG. 1, as increased downward force is applied to the plumbing ramrod to ram a blockage through the curved outlet passageway to an outlet;

FIG. 3 is a plan view of an embodiment of a plumbing tool of the present invention that includes a plumbing ramrod, a slidably-positionable stiffening sleeve, a promotional/use card removably attached to the ramrod, and separate utility/use and advertising messages permanently secured;

FIG. 4 is an end view, taken substantially as shown by view line 4-4 of FIG. 3, of the stiffening sleeve of FIG. 3;

FIG. 5 is a plan view of an opposite face of the plumbing ramrod of FIG. 3, showing optional measuring inscriptions;

FIG. 6 is an edge view of the ramrod of FIG. 3, showing the relative thinness of the ramrod of FIG. 3;

FIG. 7 is an edge view of the ramrod of FIG. 3, taken substantially the same as FIG. 6 with the stiffening sleeve of FIG. 3 selectively positioned above a curved portion of the ramrod, illustrating ramming forces;

FIG. 8 is a cross section of a plumbing tool which comprises a spring steel strip encased in a non-metallic sheath;

FIG. 9 is a cross section of a ramrod of a plumbing tool, taken substantially the same as FIG. 8, which comprises a pair of spaced-apart steel wires encased in a non-metallic sheath;

FIG. 10 is a plan view of an embodiment of a plumbing tool of the present invention in which a stiffening sleeve is welded between a flexible portion and a hanging/display portion to provide bidirectional-stiffening;

FIG. 11 is a cross-section of the flexible portion of the plumbing tool of FIG. 10, taken substantially as shown by section line 11-11 of FIG. 10;

FIG. 12 is a cross-section of the stiffening sleeve of the plumbing tool of FIG. 10, taken substantially as shown by section line 12-12 of FIG. 10;

FIG. 13 is a plan view of an embodiment of a plumbing tool of the present invention in which a first longitudinal portion includes bidirectional flexibility, a second longitudinal portion includes unidirectional stiffening, and third longitudinal portion is a hanging portion;

FIG. 14 is a cross section of the plumbing tool of FIG. 13, taken substantially as shown by section line 14-14 of FIG. 13, showing the first longitudinal portion with bidirectional flexibility;

FIG. 15 is a cross section of the plumbing tool of FIG. 13, taken substantially as shown by section line 15-15 of FIG. 13, showing a curved cross section that provides unidirectional-stiffening of the second longitudinal portion;

FIG. 16 is a cross section of the plumbing tool of FIG. 13, taken substantially as shown by section line 16-16 of FIG. 13, in which a shape of a cross section provides bidirectional stiffening for a third longitudinal portion, or handle portion;

FIG. 17 is a front elevation, taken substantially the same as FIG. 2, showing a right hand grasping the unidirectionally-stiffened plumbing tool of FIGS. 13-15, and ramming it downward while applying a torque that achieves manual stiffening in a direction opposite to that of the unidirectional stiffening of FIG. 15;

FIG. 18 is an edge view of a plumbing tool that comprises a flexible portion, a first bidirectionally-stiffened portion that is stiffened by doubling and that is formed by folding and welding, and a third bidirectionally-stiffened portion that preferably is stiffened by doubled portions, spacing apart the doubled portions, and unidirectional-stiffening of the spaced-apart doubled portions;

FIG. 19 is a plan view of the plumbing tool of FIG. 18, taken substantially as shown by view-line 19-19 of FIG. 18, showing the unidirectional-stiffening of the spaced-apart doubled portions.

FIG. 20 is a cross section of the flexible portion of the plumbing tool of FIGS. 18 and 19, taken substantially as shown by section line 20-20 of FIG. 19;

FIG. 21 is a cross section of the first bidirectionally-stiffened portion of the plumbing tool of FIGS. 18 and 19, taken substantially as shown by section line 21-21 of FIG. 19;

FIG. 22 is a cross section of the double and spaced-apart unidirectionally-stiffened portion of the plumbing tool of FIGS. 18 and 19, taken substantially as shown by section line 22-22 of FIG. 19;

FIG. 23 is a cross section of a double and spaced-apart bidirectionally-stiffened portion of the plumbing tool of FIGS. 18 and 19, taken substantially the same as FIG. 22, for optional use in the embodiment of FIGS. 19 and 20;

FIG. 24 is a longitudinal cross-section, showing the ramrod of FIGS. 1-3 inserted into a straight piece of plastic pipe and serpentinely bent to illustrate the compressive-spring characteristic of ramrods of the plumbing tools of the present invention;

FIG. 25 is an end view of the plastic pipe and the serpentinely bent ramrod of FIGS. 1-3, taken substantially as shown by view-line 25-25 of FIG. 24;

FIG. 26 is a plan view of an embodiment of the present invention in which a plumbing tool comprises a plumbing ramrod in the form of a coiled spring, a flexible sheath, a stiffening sleeve or ramming sleeve, a ramming handle, and an impacting foot;

FIG. 27 is an enlarged end view, taken substantially as shown by view line 27-27 of FIG. 26, of a stiffening sleeve for use as a part of the plumbing tool of FIG. 26;

FIG. 28 is an enlarged end view, also taken substantially as shown by view line 27-27 of FIG. 26, of a ramming sleeve for use as a part of the plumbing tool of FIG. 26, showing the non-circular hole that provides self locking;

FIG. 29 is a partial and a greatly enlarged end view of the ramming sleeve of FIG. 28, taken substantially the same as FIG. 28, showing the non-circular opening that provides self-locking;

FIG. 30 is a plan view of a plumbing tool, with a portion broken out, that includes a coiled steel spring as the ramrod, a sheath, a positioning handle, a bellows, and a slide hammer;

FIG. 31 is a front elevation of a power-impacting plumbing tool that includes an electric hammer, a chuck attached to the electric hammer, and a power-impacting ramrod, such as a power-impacting ramrod of FIG. 32, or the ramrod of FIG. 26, secured in the chuck;

FIG. 32 is a cross-section of a power-impacting end of a power-impacting member for use with power-impact-ramming plumbing tools, such as electric hammers, in which a spaces between the impacting head 316 and the impacting hammer 306 provide means or applying a select portion of the impacting stroke to the ramrod 226, and in which a bellows allows power-impacting the ramrod 226 without impacting the sheath 228;

FIG. 33 is a cross section of a power-impacting plumbing tool which comprises an electric drill, and a rotary-to-impact converter that converts rotary motion into power impacts, and a ramrod in the form of a coiled steel spring chucked into the electric drill;

FIG. 34 is an enlarged end view, taken substantially as shown by view line 34-34 of FIG. 26, illustrating a stiffening sleeve, or positioning handle, that includes unidirectional stiffening as taught in conjunction with FIGS. 14 and 16, for use with embodiments such as FIGS. 26, 30, 31, 32, and 33;

FIG. 35 is a cross-sectioned longitudinal view of a plumbing tool in which the ramrod thereof includes a plurality of stacked steel strips, or steel ribbons, enclosed in an extruded plastic sheath, an impacting foot, a power ramming head, and a chucking shaft.

FIG. 36 is a cross sectional end view of the plumbing tool of FIG. 35, taken substantially as shown by Section Line 36-36 of FIG. 35, showing the stacked steel ribbons enclosed in the extruded plastic sheath; and

FIG. 37 is a longitudinal view of edges of the stacked steel ribbons of the ramrod of FIG. 35, taken substantially as shown by View Line 37-37 of FIG. 35, showing the steel ribbons welded together at a midpoint between ends thereof, and showing pressure applied to the steel ribbons proximal to one end thereof to restrain longitudinal movement between adjacent ones of the steel ribbons.

### DETAILED DESCRIPTION OF THE INVENTION

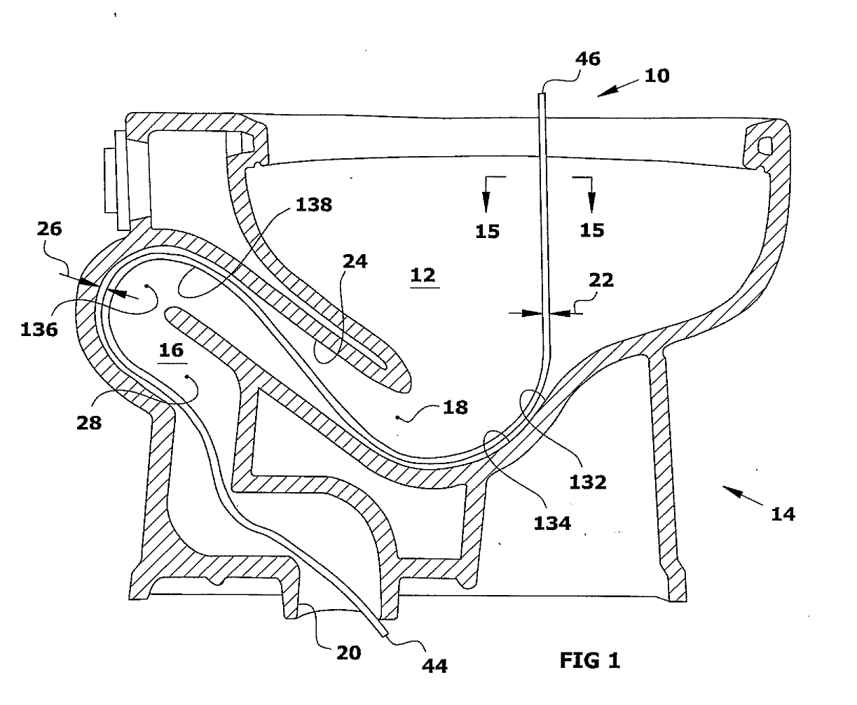

Referring now to FIG. 1, a plumbing ramrod 10 is shown threaded downward into a toilet bowl 12 of a toilet stool 14, entering a curved discharge passageway 16 at an entrance 18 thereof, curving complexly through the curved discharge passageway 16, and exiting the toilet stool 14 at an outlet 20. As the ramrod 10 has been forced downwardly and threaded through the curved discharge passageway 16, it has bent flexibly or elastically to more or less follow the curved discharge passageway 16.

The plumbing ramrod 10 has flexibility, as determined by a thickness 22 and the modulus of elasticity of the material, that allows flexing in the curved discharge passageway 16, as shown, without exceeding the tensile strength of the material, but with a stiffness that will prevent crumpling of one portion of the ramrod 10 against another portion in the curved discharge passageway 16.

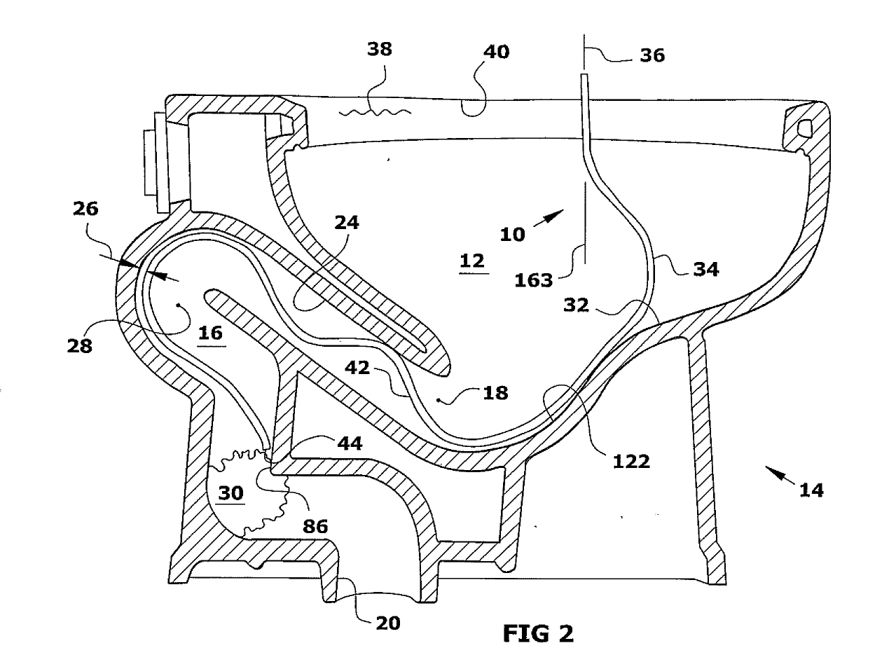

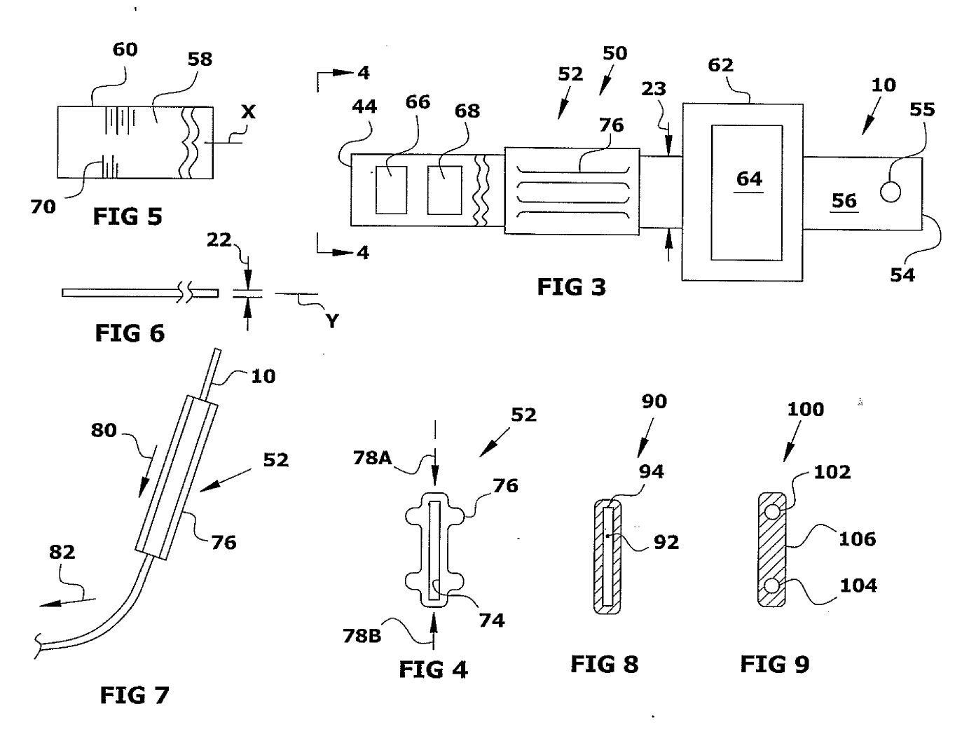

The plumbing ramrod 10 is rectangular in cross section, has a width 23 as shown in FIG. 3. Because of the width 23, the ramrod 10 cannot move closer to a surface 24 than a distance 26 of FIGS. 1 and 2.

As shown in FIG. 1, as the plumbing ramrod 10 is threaded through the curved discharge passageway 16, it follows a path of least resistance, sometimes close to the surface 24 of the curved discharge passageway 16, never being closer than the distance 26, and sometimes being nearer to a center 28 of the passageway 16.

Referring now to FIG. 2, as a user, not shown, places additional downward force on the plumbing ramrod 10 in an attempt to dislodge a blockage 30, the additional downward force tends to bend the ramrod 10 around a contour 32 of the toilet bowl 12, thereby initiating buckling of the ramrod 10, as shown by a buckled portion 34. Initial buckling moves the downward force on the buckled portion 34 farther from a center 36 of the ramrod 10, so initial buckling, as illustrated by the buckled portion 34, decreases the force that will additionally buckle the ramrod 10.

Assume that the toilet bowl 12 of FIG. 2 is full of dirty water 38 almost up to a rim 40 of the toilet bowl 12. Because of the tendency of the ramrod 10 to buckle, additional stiffening of the plumbing ramrod 10 is highly desirable, so that it will not be necessary for users to get their hands into the dirty water.

As shown in FIG. 2, the increase in downward force applied to the plumbing ramrod 10 causes serpentine bending 42 of the ramrod 10 inside the curved discharge passageway 16.

While a plumbing ramrod, such as the plumbing ramrod 10 can be used as one embodiment of the plumbing tools described and claimed herein, preferably all other embodiments include stiffening of a longitudinal portion of a ramrod. Stiffening, whether bidirectional or unidirectional, comprises increasing a section modulus.

Buckling of the ramrod 10 occurs, as described above, when a constant downward force is applied. However, when the ramrod 10 is rapidly rammed downwardly, a larger force can be applied without excessive buckling.

Preferably, the thickness 22, the modulus of elasticity of the material, and tensile strength of the material of the ramrod 10 combine to prevent a bending stress that could exceed tensile strength of the plumbing ramrod 10, so that ramrod 10 will resume the straight shape of a yardstick. However, plumbing ramrods that are made of extruded plastic may require manually straightening after removal from curved discharge passageways 16.

Bending of the plumbing ramrod 10 in the curved discharge passageway 16 is similar to a beam. When a beam is subjected to a load, if the beam has a lower section modulus transverse to the load, and if the beam can twist sufficiently, the beam will twist and fail in bending with respect to the lower section modulus.

In like manner, as the plumbing ramrod 10 is threaded through the curved discharge passageway 16, the ramrod 10 will rotationally orient to conform bending to the width 23. That is, the lower section modulus of the dimension 22 will keep the width 23 of the ramrod 10 transverse to the curved discharge passageway 16, as shown in FIGS. 1 and 2.

Referring now to FIGS. 3-6, a plumbing tool 50 includes the ramrod 10 and a bidirectional stiffening sleeve, or ramming handle, 52. The ramrod 10 includes the width 23, an impacting end 44, a ramming end 54, a hole 55 for display or storage, and a first surface 56, all of FIG. 3; a second surface 58 and edges 60 of FIG. 5; and the thickness 22 of FIG. 6.

Preferably, the ramrod is extruded plastic with a ductility and high tensile strength such as Nylon or polyvinyl chloride.

As a retail sales item, preferably, the plumbing tool 50 includes a use card 62 with a picture and/or words 64 that proclaim the utility of the plumbing tool 50, so that potential buyers will understand its use.

As a promotional item or an advertising gift item, the plumbing tool 50 includes a first message, or utility/use information 66 on a surface 56 or 58, and a second message, or advertising message 68 on a surface 56 or 58. Optionally, the plumbing tool 50 may include dimensional inscriptions 70 in inches and/or in centimeters.

As shown in FIG. 4, the stiffening sleeve, or ramming handle, 52 includes a rectangular opening 74 for slidably receiving the thickness 22 and the width 23, and ribs 76.

Referring now to FIG. 7, the stiffening sleeve 52 of FIGS. 3, 4, and 7 is selectively positioned and repositioned to prevent the ramrod 10 from buckling, as illustrated by the buckled portion 34 of FIG. 2, and to keep a user's hands, not shown, out of the dirty water 38 of FIG. 2.

Referring again to FIG. 4, the stiffening sleeve 52 is extruded from plastic with a relatively low modulus of elasticity, so that, in response to manual pressure in the direction of the arrows 78A and 78B, the stiffening sleeve 52 securely grips the ramrod 10 of FIG. 7.

Referring now to FIGS. 1, 2, 3, and 7, when a user, not shown, rams the ramrod 10 downwardly as shown by an arrow 80 of FIG. 7, or swings the ramrod 10 inwardly, as shown by an arrow 82, plunging the ramrod 10 downward, the serpentine bending 42 of FIG. 2 will occur.

Referring now to FIG. 8, a ramrod 90, which may be used with or without the stiffening sleeve 52 in any suitable embodiment of the plumbing tools of the present invention, includes a spring steel strip, or spring steel ribbon, 92 inside an extruded plastic sheath 94.

Referring now to FIG. 9, a ramrod 100, which may be used with or without the stiffening sleeve 52, includes spring steel wires, 102 and 104, which may be of equal or unequal diameters or shapes, inside an extruded plastic sheath 106.

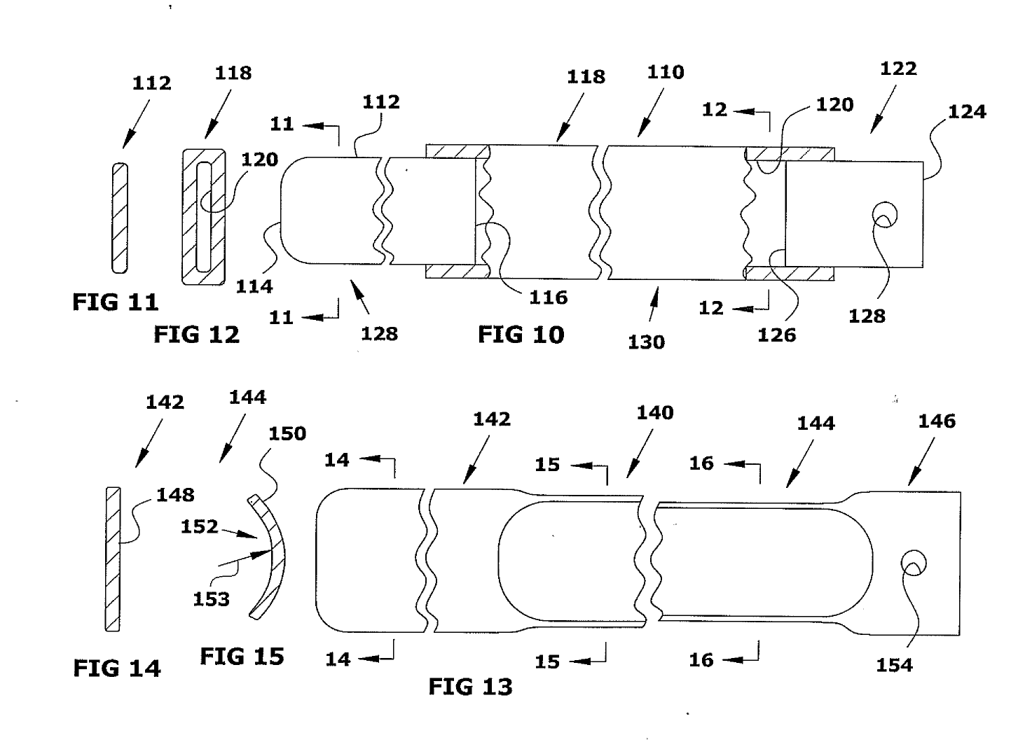

Referring now to FIGS. 10-12, a plumbing tool 110 includes a ramrod 112 with an impacting end 114 and a welding end 116, a stiffening sleeve 118 with a rectangular opening 120, and a hanging portion 122 with a ramming end 124, a welding end 126, and a hanging hole 128. The ramrod 112 is inserted into the rectangular opening 120 and welded thereto. In like manner, the hanging portion 122 is inserted into the rectangular opening 120 at another end of the stiffening sleeve 118 and welded thereto.

After assembly as described above, the plumbing tool 110 includes the ramrod 112, that extends from the impacting end 114 to the stiffening sleeve 118, a stiffening portion 130, and the hanging portion 122.

As described above, the portion 128 of the ramrod 112 has one stiffness, and the portion 130 has a greater stiffness. However, preferably, the plumbing tool 110 includes three portions, each with a different section modulus, or stiffness.

More particularly, by extending the end 126 of the plumbing tool 110 of FIG. 10 into the sleeve 118, the plumbing tool 110 includes three different portions: a first portion having the section modulus and flexibility of the ramrod 112, a second portion having the section modulus and stiffness of the sleeve 118, and a third portion having a section modulus and stiffness that includes both the sleeve 118 and the hanging portion 122.

Referring again to FIG. 1, to accommodate all makes and models of toilet stools, stiffened portions of the plumbing ramrods should extend from the curve origination 132 about half way to a sharpest turn 136 of the curved discharge passageway 16.

More particularly, plumbing tools must have sufficient flexibility to transverse the sharpest turn 136; but can be considerably stiffer from the sharpest turn 136 to the curve origination 132, because the curve 134 is not nearly as sharp, and a handle portion, can be, and ideally is, even stiffer. As shown in FIG. 1, a handle portion, not shown, can extend from the ramming end 46 to the sharper bend 138 in the curved discharge passageway 16, if the handle portion is sufficiently flexible to bend as illustrated by the ramrod 10.

Referring now to FIGS. 13-15, a plumbing tool 140 includes a ramrod, biflexible portion, or first longitudinal portion, 142, a unidirectionally-stiffened portion 144, and a hanging portion 146. The first longitudinal portion 142 has a rectangular cross section 148 as shown in FIG. 14; the unidirectionally-stiffened portion 144 includes a curved cross section 150 with a concave surface 152 that includes a radius 153, as shown in FIG. 15; and the hanging portion 146 has a cross section that is the same as the cross section 142, and that includes a hanging hole 154.

Referring now to FIG. 17, the plumbing tool 140 of FIGS. 13-15 is shown actuated by a right hand 156 of a user, not shown. The user is ramming the plumbing tool 140 downward at an angle 158 toward the opening 18 of FIG. 2 as shown by a vector 160. In addition, by slightly rotating the hand 156, the user is placing a rotational force on the plumbing tool 140 as shown by a torque vector 162.

As shown by a stiffening line 163 of FIG. 2, the unidirectional stiffening of the cross section 150 of FIG. 15 will prevent buckling opposite to the buckled portion 34 of FIG. 2, but will not provide any stiffening in the direction that would prevent the buckling illustrated by the buckled portion 34 of FIG. 2.

It might seem that unidirectional stiffening is in the wrong direction. However, if unidirectional stiffening were provided in the opposite direction, the plumbing tool 140 would be too stiff to bend through the curved discharge passageway 16 of FIGS. 1 and 2.

This problem is solved in a unique way: unidirectional stiffening, which is structural stiffening, is combined with manual stiffening, as illustrated by the torque vector 162 of FIG. 17, to prevent buckling as illustrated by the buckled portion 34 of FIG. 2. That is, unidirectional stiffening of the plumbing tool 140 provides rigidity for receiving manual stiffening.

As the user twists the hand 156, manual stiffening is provided as shown by the torque vector 162. It is this manual stiffening that prevents the buckling of FIG. 2. Therefore, in the embodiment of FIGS. 13-15, effective ramming of a blockage 30 is achieved by combining structural stiffening with manual stiffening.

Referring now to FIGS. 13, 15, and 16, preferably the plumbing tool 140 includes three different longitudinal portions each having its own section modulus and flexibility or stiffness. In addition to the flexible portion 142 and the unidirectionally stiffened longitudinal portion 144, the plumbing tool 140 includes a handle portion that is bidirectionally stiffened.

Referring now to FIG. 15, to achieve unidirectional stiffening, the tensile strength of the flexible member 112, its modulus of elasticity, and the radius 153 of the cross section 150 must allow the radius 153 to increase without exceeding tensile strength of the flexible member 112. This does not necessarily mean that the cross section 150 must flatten, but the radius 153 must be able to increase.

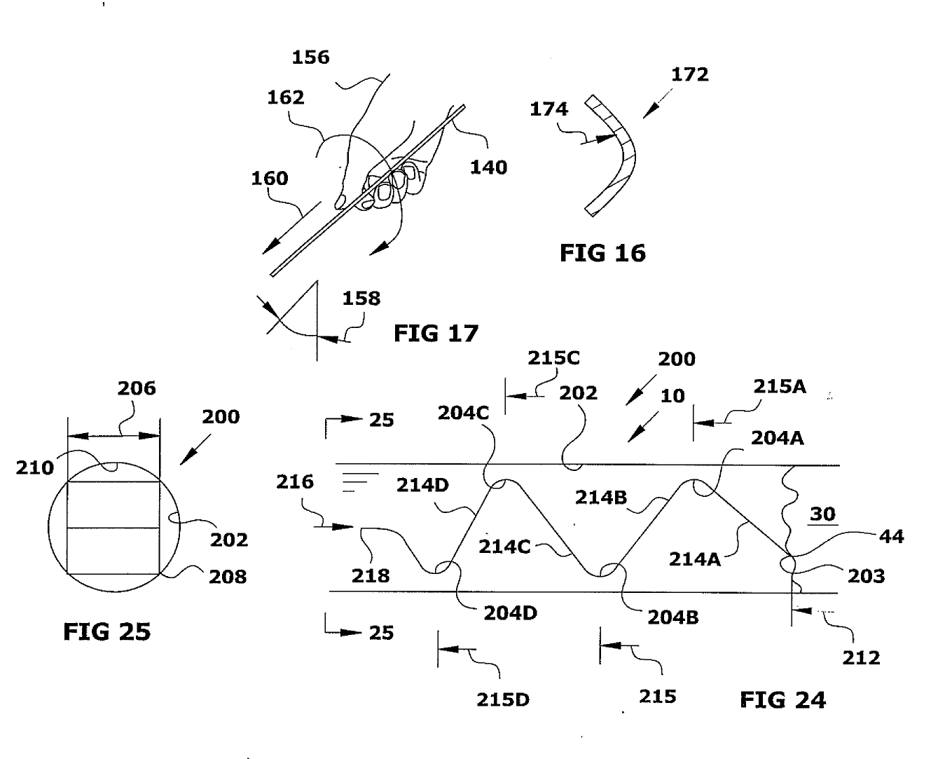

Referring now to FIGS. 15 and 16, a bidirectionally-stiffened, or handle portion, not shown, of the plumbing tool 140 is provided by forming a longitudinal portion at Section-Line 16-16 with a cross section 172. The change from unidirectional stiffening of the cross section 150 of FIG. 15 to bidirectional stiffening of the cross section 172 is accomplished by making a radius 174 smaller than the radius 153. The sizes of the radii 153 and 174 can be calculated for a selected material by anyone skilled in the art for any selected materials.

Referring again to FIGS. 13-16, preferably the plumbing tool 140 is made by extruding the rectangular cross section 148 of FIG. 14, rolling the radius 153 into a longitudinal portion to form the cross section 150 as it leaves an extrusion machine, and rolling the radius 174 into another longitudinal portion to form the cross section 172, and leaving the hanging portion 146 as extruded.

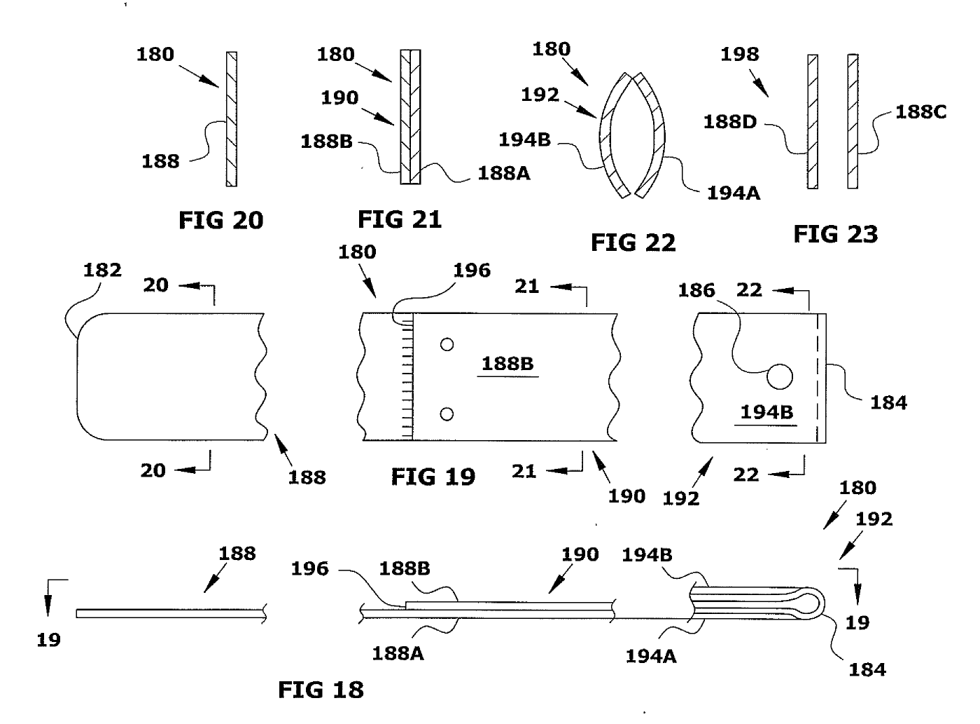

Referring now to FIGS. 18 and 19, a plumbing tool 180 includes an impacting end 182 which may be rounded as shown, a ramming end, or doubled end, 184, a hanging hole 186, a flexible ramrod portion 188, a bidirectionally-stiffened portion 190, and a handle portion, 192.

Preferably, plastic is extruded as a rectangular strip and reformed as it leaves an extrusion machine to provide the unidirectional stiffening shown in FIG. 22, a length is folded over to provide both the bidirectionally-stiffened portion 184 and the handle portion 192, and the end 196 is welded to the flexible portion 188.

Each of the three longitudinal portions, 188, 190, and 192, have a different section, so each has a different stiffness. The portion 188 has sufficient flexibility for threading through the curved discharge passageway 16 of a toilet stool 14, the portion 190 has a greater stiffness, but still has flexibility for threading part way through the curved discharge passageway 16, and the handle portion 192 has a section modulus and stiffness sufficient for preventing the buckling 34 of FIG. 2.

When the handle portion 192 is formed as shown in FIG. 22, its section modulus includes spaced-apart unidirectionally-stiffened portions 194a and 194b. However, if made as shown in FIG. 23, the handle portion 198 has a section modulus that comprises spaced-apart members 188c and 188d.

Referring now to FIGS. 22 and 23, a section modulus of the handle portion 192 of FIG. 22 is increased by a space, as shown, between the unidirectionally-stiffened portions 194a and 194b. In like manner, a section modulus of the handle portion 198 of FIG. 23 is increased by a space, as shown, between the non-stiffened portions 188c and 188d.

FIG. 24 illustrates compressive-elasticity, compressive energy storage, and elastic transfer of energy when the ramrod 10 is bent and impactly rammed in the curved discharge passageway 16 of FIGS. 1 and 2.

More particularly, FIG. 24 illustrates how friction between a ramrod, such as the ramrods 10, 112, 142, or 188 in the curved discharge passageway 16 affects curvatures of the ramrod as the ramrod elastically stores and transfers energy, thereby essentially obviating friction.

In FIG. 24, the ramrod 10 of FIGS. 1-3 is shown inserted into a straight piece of tubing 200 that has an inside diameter 202 of 2.0 inches (50.8 mm), and forced against a blockage 30. The impacting end 44 of the ramrod 10 is shown bent against the blockage 30 at an impacting point 203, and the ramrod 10 is serpentinely bent against the inside 202 of the tube 200 at contact points 204a, 204b, 204c, and 204d.

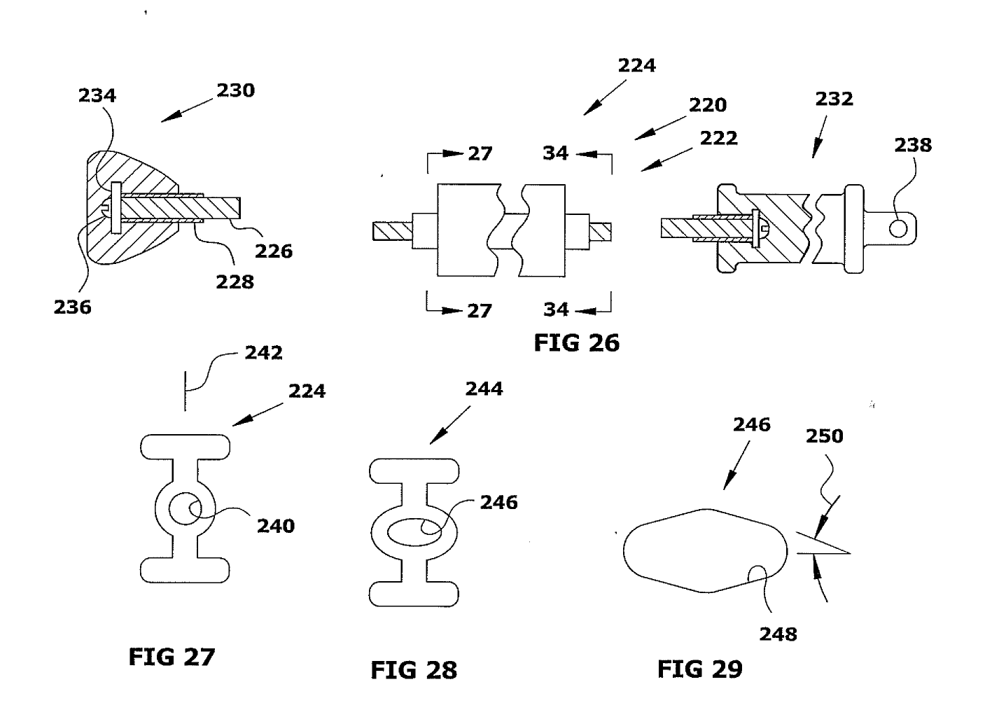

Referring now to FIG. 25, any ramrod with a rectangular cross-section, that has a width 206, will contact the inside diameter 202 at a pair of contact points 208. Plumbing tools that use a coiled steel spring for the ramrod such as the plumbing tool of FIG. 26, will contact the inside diameter 202 at a single contact point 210 of the inside diameter 202.

Whether a ramrod contacts the inside diameter 202 at a pair of contact points 208 or at a single contact point 210, impact ramming, combined with the compressive elasticity of the ramrod, such as the ramrod 10, essentially overcomes friction as discussed below.

Plumbing tools that use a coiled steel spring for the ramrod, such as the plumbing tool of FIG. 26, will bend serpentinely as shown in FIG. 24, except that the serpentine bending will not necessarily be in a single plane.

In contrast, any ramrod that has a section modulus considerably greater with respect to one plane will bend serpentinely with respect to a single plane whenever the passageway bends, because the ramrod will rotate to align the bend with its smallest section modulus.

In FIG. 24, the impacting end 44 of the ramrod 10 is engaging the blockage 30, so that a resistance force 212 of the blockage 30 causes the ramrod to bend with a curvature 214a. A friction load 215a at the contact point 204a adds to the total force needed to move the blockage 30.

In like manner, friction loads 215b, 215c, and 215d, at contact points 204b, 204c, and 204d, add to a force 216 that is required to drive the blockage 30 through the tube 200, which represents the curved discharge passageway 16 of FIG. 2.

Assume that the force 216 is slowly, but progressively increased. Instead of the force 216 being, more or less, equally distributed among the friction loads 215a-215d, the force 216 first overcomes the friction load 215d, the force 216 then increases the curvature 214d, and the increase of energy of the increased curvature 214d overcomes the friction load 215c. That is, the force 216 is rippled past each successive friction load, 215d-215a.

Even as a row of dominoes goes down, in response to the force 216, friction is overcome as curvatures 214d-214a are increased, the energy of the curvatures 214d-214a is increased, and increased energy transfers to successive ones of the friction points 215d-215a.

Therefore, because of the compressive elasticity of plumbing tools of the present invention, and the resultant elastic-energy transfer, the plumbing tools of the present invention are much more effective in removing blockages than former apparatus and/or method.

Even with a slowly applied, but increasing force 216, energy is elastically transmitted somewhat like dominos sequentially knocking down the next domino. Therefore, it is easy to see that, when the end 218 is repetitively impact-rammed with the force 216, the plumbing tools of the present invention are even more effective than when merely rammed.

As every mechanic knows, objects can be moved by repeated impacts when they cannot be moved by applying a steady force. In addition, as set forth above, the compressive elasticity of the ramrods of the plumbing tools of the present invention, combined with energy transfer past friction points, make the plumbing tools of the present invention more effective than merely impacting a mass.

Further, all of the ramrods of the plumbing tools of the present invention have compressive elasticity, all have a unit mass per unit length, and when impacted against a blockage in a curved discharge passageway 16, all function in accordance with their compressive elasticity and their distributed mass.

Therefore, in addition to the domino effect at taught above, an impact applied to a ramming end 218 is distributed along the ramrod 10 in accordance with the compressive elasticity of the ramrod 10, the distributed mass of the ramrod 10, and the distributed friction of the contact points 204d, 204c, 204b, and 204a.

However, power-impact ramming, as taught herein, does not always bend the ramrod into full contact with discharge passageways, especially when ramrods are made from coiled wire or steel ribbons. Instead, as a function of both ramming frequency and ramming strokes, rapidly-successive serpentine waves of the ramrod are propagated, and the serpentine waves rattle through discharge passageways to effectively clear the passageways without making full serpentine contact with the passageways.

In these instances, friction is greatly reduced because the ramrod is not forced into full contact with the discharge passageway. Instead, friction contact of the ramrod with the discharge passageway 16 is erratic and sporadic, so that friction is essentially eliminated. The blockage 30 is cleared, primarily, by the aforesaid waves whipping the ramming end 44.

Referring now to FIG. 26, a plumbing tool 220 includes a ramrod 222 and a stiffening sleeve 224. The ramrod 222 includes a coiled steel spring 226, a sheath 228, and the plumbing tool includes an impacting foot 230, and a ramming handle 232.

Preferably, the coiled steel spring 226 is wound with closed coils, such as used to make plumbing snakes. Optionally, portions, or entire lengths, may be wound with spaces between coils, so that ramming energy can be transmitted in waves from the ramming handle 232 to the impacting foot 230.

A washer 234 is attached to the coiled steel spring 226 with a screw 236. Then the impacting foot 230 is molded over the coiled steel spring 226, the sheath 228, and the washer 234 to attach the impacting foot 230 securely to the coiled steel spring 226. The ramming handle 232 is attached to the coiled steel spring 226 and the sheath 228 in like manner. Preferably, the ramming handle 232 includes a hole 238 for hanging the plumbing tool 220 on a display rack, not shown, or for convenience in home storage.

Referring now to FIGS. 26 and 27, the stiffening sleeve 224 has any suitable cross sectional shape, has a section modulus with respect to a bending axis 242, as desired, and includes an opening 240, shown in FIG. 27, that slidably receives the sheath 228. Preferably, the stiffening sleeve 224 is plastic.

Referring now to FIGS. 26 and 28, optionally a ramming sleeve 244 of FIG. 28 may be used with the plumbing tool 220 of FIG. 26 in place of the stiffening sleeve 224. As shown in FIGS. 28 and 29, the ramming sleeve 244 includes an opening 246 that is not circular.

As shown in FIG. 29, the opening 246 includes four wedging surfaces 248 at angles 250 that will wedge onto the sheath 228 of FIG. 26 anytime a ramming force on the ramming sleeve 244 bends the coiled steel spring 226.

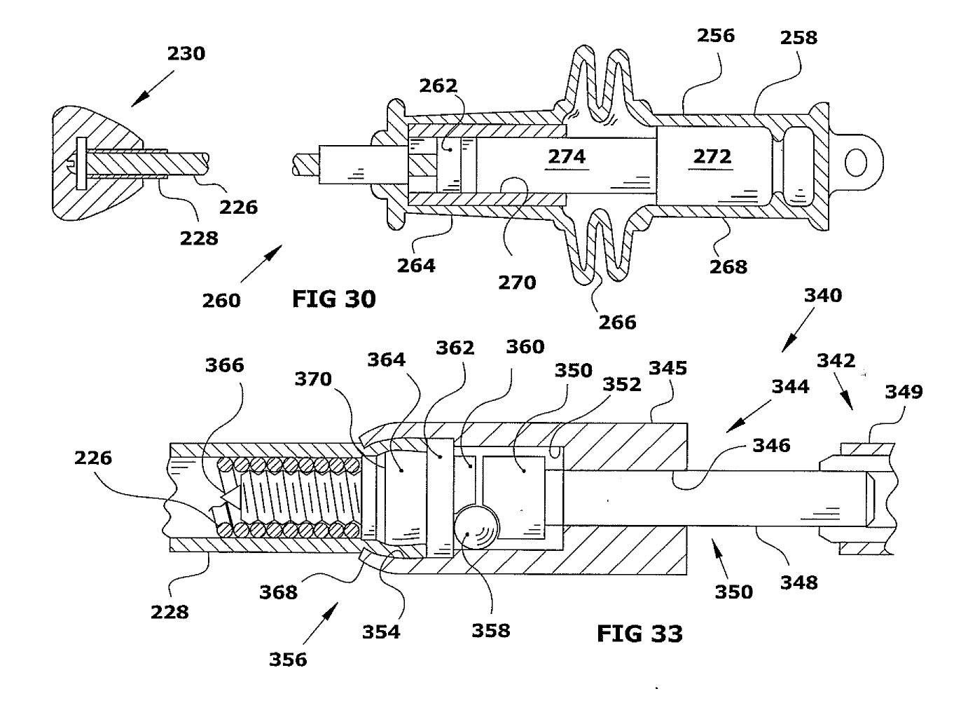

Referring now to FIG. 30, a plumbing tool 260 includes both the coiled steel spring 226 and the sheath 228. The coiled spring 226 is fastened to the impacting foot 230 and to a ramming head 262 by steel screws, not shown, engaging the coiled spring 226, as shown in FIG. 26.

The sheath 228 is also bonded into a first end of a positioning handle 264. A second end of the positioning handle 264 is integral with a first end of a bellows 266, and a second end of the bellows 266 is bonded to a slide-hammer handle 268. The coiled steel spring 226 is hydraulically sealed inside the sheath 228, the positioning handle 264, the bellows 266, and the slide hammer handle 268.

A cylindrical guide sleeve 270 is disposed inside the positioning handle 264, and the guide sleeve 270 slidably receives the ramming head 262. A slide hammer 272 is fixedly disposed inside the slide hammer handle 268 and a reduced diameter portion 274 of the slide hammer 272 slidably engages the inside of the guide sleeve 270 for a distance that effectively guides reciprocating movement of the slide hammer 272 and the slide hammer handle 268.

Longitudinal elasticity of the sheath 228 allows impacts applied to the impacting foot 230, through the coiled steel spring 226, to jerk the sheath 228 though the curved discharge passageway 16. Jerking the sheath 228 effectively overcomes friction between the sheath 228 and the curved discharge passageway 16, thereby delivering greater impacts to the blockage 30, as opposed to driving the coiled steel spring 226 and the sheath 228 through the curved discharge passageway 16. This advantage is achieved by all plumbing tools that have a steel coiled spring in a sheath.

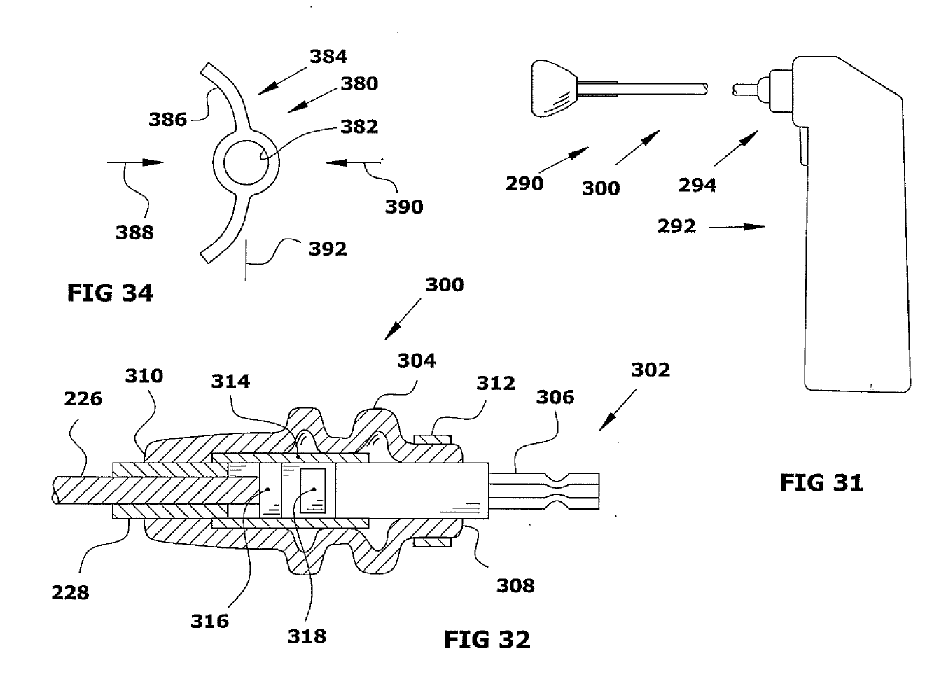

Referring now to FIG. 31, a power-impacting plumbing tool 290 includes a power-impacting device, electro-mechanical impacting device, or an electric hammer 292, and a chuck 294, and the power-impacting ramrod 300 of FIG. 32.

Any suitable electric hammer, such as the Altocraft™ auto-hammer, model 241-0250, when attached to the plumbing tool, such as the power impacting ramrod 300 of FIG. 32, by any suitable means, such as the chuck 294, becomes a power-impacting plumbing tool. Any suitable chuck can be used that will attach an impacting end 302 of the power-impacting ramrod to the electric hammer 292.

Referring now to FIG. 32, the power-impacting ramrod 300 is constructed generally as shown in FIG. 26. The power-impacting ramrod 300 includes, in addition to the power-impacting end 302 of FIG. 32, the coiled steel spring 226, the sheath 228, and the impacting foot 230 of FIG. 26.

The impacting end 302 includes a bellows boot 304 that receives an impact hammer 306 at a first end 308 and receives the coiled steel spring 226 enclosed in the sheath 228 at a second end 310. At the first end 308, a compression ring 312 seals the bellows boot 304 to the impact hammer 306. At the second end 310, the bellows boot 304 is molded to the sheath 228.

A guide tube 314 is molded inside the bellows 304 coaxial with the coiled steel spring 226, and both the impact hammer 306 and the impacting head 316 are slidably inserted into the guide tube 314. The impacting head 316 is attached to the coiled steel spring 226 by a screw as taught in conjunction with FIG. 26.

Optionally, a shock-reducing pad 318 is inserted between the impacting hammer 306 and the impacting head 316 to soften the impacts delivered to the impacting head 316 by the impact hammer 306 and the electric hammer 292 of FIG. 31.

Referring now to FIG. 33, a power-impacting plumbing tool 340 includes a rotary-power device, or electric drill 342, a rotary-to-impact converter 344, a ramrod, a sheath, and an impacting foot, such as the ramrod 226, the sheath 228, and the impacting foot 230 of FIG. 30. The power-impacting plumbing tool 340 may also include any sleeve or stiffening device shown and described herein.

The rotary-to-impact converter 344 includes a housing 345 with three bores: a first bore 346 that slidably receives a shaft 348 of a rotary cam, or impact hammer, 350, a second bore 352 that receives the rotary cam 350, and a third bore 354 that receives a cam and connector 356, and a steel ball 358.

The cam and connector 356 includes a stationary cam 360 that is disposed in the second bore 352, a larger cylindrical portion 362 disposed in the third bore 354, a second cylindrical portion 364 that slidably receives the sheath 228 and that is disposed in the third bore 354, and an integral screw 366 that is screwed into the coiled steel spring 226.

An end 368 of the housing 345 is rolled, or swaged, over the sheath 228 and a chamfer 370 of the second cylindrical portion 364 of the cam and connector 356, as shown, thereby sealing the rotary-to-impact converter 344 of the power-impacting plumbing tool 340.

In operation, the shaft 348 is chucked into a chuck 349 of the electric drill 342. The power-impacting plumbing tool 340 is moved toward a blockage 30 in the stool 14 of FIG. 2 so that the rotary cam 350 repeatedly hammers the ball 358 against the stationary cam 360, thereby repeatedly impacting the blockage 30. The power-impacting plumbing tool 340 device is moved toward the blockage 30 at a speed, and/or with a force, that provides whatever effective impacting stoke is desired. Because the ball 358 is securely retained in the bore 352 of the housing 345, there is no particular limit to acceptable movement of the rotary cam 350 toward, and away from, the stationary cam 360. It is merely a design preference.

Referring now to FIG. 34, as extruded, a unidirectionally stiffened sheath 380 includes an opening 382 and a pair of concave stiffening wings 384. The stiffening wings 384 function as taught in conjunction with FIGS. 13 and 15 to provide unidirectional stiffening. That is, looking down at FIG. 34, if a bottom (not shown) is held vertically, at a top (not shown), the unidirectionally stiffened sheath 380 is stiffened, by a curved 386, to resist bending with respect to a force 388, but is more easily bent in response to a force 390.

Subsequent to extrusion, a longitudinal portion (not shown), is reshaped to obviate unidirectional stiffening of the second portion. That is, in the aforesaid longitudinal portion, the concave stiffening wings 384 are heat forged to conform to a plane 392. The unidirectionally stiffened sheath 380 may be used to replace the sheath 228 in any embodiment with a ramrod that needs a sheath to protect porcelain surfaces of a toilet stool 14 of FIG. 1.

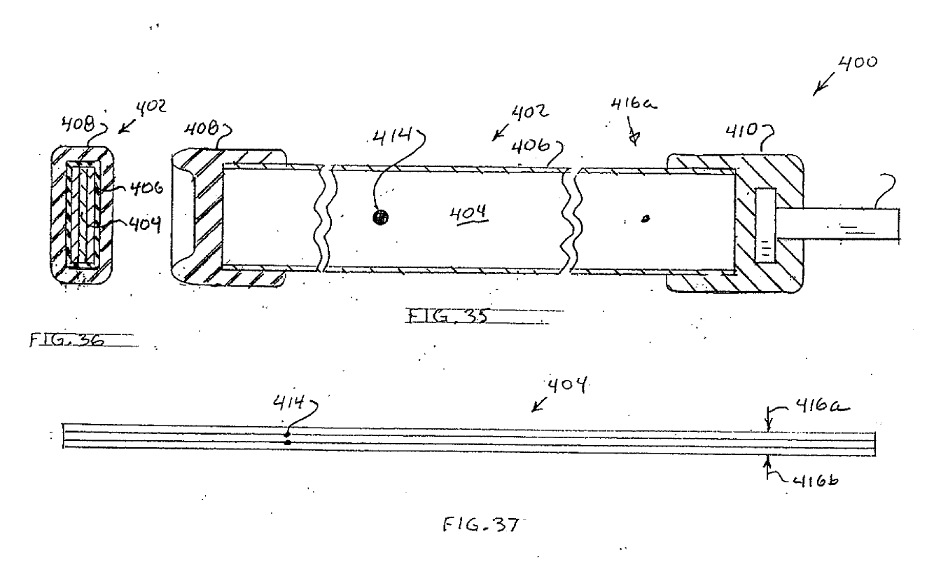

Referring now to FIGS. 35-38, but more particularly to FIG. 35, a plumbing tool 400 includes a ramrod 402 that includes a plurality of spring steel strips or ribbons 404, an extruded plastic sheath 406, an impacting foot 408, and a ramming head 410 with a chucking shaft 412. The stacked steel ribbons 404 are shown in both FIGS. 36 and 37, and the extruded plastic sheath 406 is shown in FIG. 36. The steel ribbons have a thickness 414 as shown in FIG. 37.

As shown in FIGS. 35 and 37, the steel ribbons 404 are welded together with spot welds 416 intermediate of the impacting foot 406 and the ramming head 408, so the steel ribbons 404 can move longitudinally, one on another, on either side of the spot welds 404, as the steel ribbons 404 are flexed through the discharge passageway 28 of FIGS. 1 and 2.

If three steel ribbons 404 are used, the bending stress for a curvature through the discharge passageway 28 is the same as for one ribbon. But the three ribbons 404 increase the total stiffness by a factor of three, so that while three ribbons providing the same flexibility as one, they provide a greater stiffness that helps prevent buckling.

However, if clamping forces 418a and 418b are applied to the steel ribbons 404 proximal to the ramming head 408, by any means or apparatus, not an inventive part of the present invention, longitudinal movement between adjacent ones of the steel ribbons 404 is restricted, so that stiffness in the longitudinal portion of the ramrod 402 between the welds 416 and the ramming head 408 is greatly increased.

With the clamping forces 418a and 418b as shown, if three steel ribbons 404 are used, instead of the stiffness of the ramrod 402 between the spot welds 416 and the clamping forces 418a and 418b being a function of the cube of half of the thickness 414 of one of the steel ribbons 404, the stiffness becomes a function of the cube of a dimension that is three times larger. That is, the increased stiffness may be as much as 27 times higher than the stiffness of one of the ribbons 402, depending upon the effectiveness of the clamping forces 416a and 416b in restricting longitudinal movement between adjacent ones of the steel ribbons 404.

Alternately, instead of the clamping force of the arrows 418a and 418b, spot welds proximal to the ramming head 410 may be used to achieve increased stiffness in the longitudinal portion proximal to the ramming head.

Preferably, the method of manufacture of the embodiment of FIGS. 35-37 includes purchasing spring steel strips that are flat, but rolled elastically for shipment, feeding two or more of the spring steel strips together, welding the spring steel strips together between rolls that are contoured to provide welds as desired, extruding the welded strips into the sheath 404, shearing the steel strips to their desired lengths, and injection molding ramming heads 408 and impacting feet 406 to the sheared lengths.

The plumbing tool 400 may be used with any suitable reciprocating and/or rotating power impacting device by chucking the chucking shaft 412 into the power impacting device, or may any other suitable means. There is no need for any guiding or stiffening device, except that any suitable clamp, not shown, not an inventive part of the present invention, may be applied to the ramrod 400 proximal to, or as a part of the ramming head 410.

When used with a reciprocating device, such as the auto-hammer 292 of FIG. 31 or a saber saw, preferably some device, with a space between an impacting head and an impacting anvil, such as is taught in conjunction with the power-impacting ramrod 300, is provided so that the user can use only a portion of the impacting stroke. Otherwise, the plumbing tool 400 will reciprocate in accordance with the impacting stroke of the impacting device.

When the plumbing tool 400 is used with a rotary device, such as the electric drill 342, the rotary-to-impact converter 340 provides means for selectively utilizing only a portion of the impacting stroke of the rotary-to-impact converter.

While not necessary, having the ability to use only a part of the stroke allows ramrods to rattle through discharge passages without making full serpentine contact with the discharge passageway, as discussed in conjunction with FIGS. 24 and 25. Or if the user desires to take full advantage of energy transferring, as also discussed in conjunction with FIGS. 24 and 25, the ability of using only a portion of the impacting stroke allows the user to maintain full serpentine bending.

Further, when the plumbing tool 400 is used with a rotary device, such as the electric drill 342 and the rotary-to-impact converter 340, conversion of rotary motion to reciprocating motion results in a torque being applied to the ramrod 402. While some initial rotation will occur as the ramrod 402 enters the curved discharge passageway 16, as the ramrod 402 starts to bend to follow the curved discharge passageway 16, bending of the smaller section modulus of the plurality of thicknesses 414 will restrain full rotation.

When a ramrod, with a section modulus with respect to one axis is substantially equal to a section modulus around another axis, such as coiled steel spring, is inserted into a curved discharge passageway, the ramrod will rotate more or less when impactly driven by an electric drill and a rotary-to-impact converter. But when used with a ribbon-type ramrod, such as the ramrod 402, rotation will be only oscillatory. However, when a ribbon-type ramrod is used in a substantially straight discharge passageway, rotation may be continuous.

In summary, various embodiments of the present invention impactly drive blockages through plumbing passages without rotation, with full rotation, or with oscillatory rotation.

The method of the present invention comprises: flexibly threading, or elastically threading, a ramrod into a curved discharge passageway of a toilet bowl, or a discharge passageway of a drain pipe, proximal to a blockage; ramming, or elastically impacting, the ramrod against the blockage together with rotation of the ramrod, with oscillatory rotation of the ramrod, or without rotation; and/or elastically compressing, stiffening or unidirectionally stiffening the ramrod, using a plurality of stacked ribbon ramrods, welding a plurality of ribbon ramrods at one or two longitudinally spaced locations, selectively clamping ribbons ramrods together, disposing a stiffening sleeve over the ramrod, slide-hammering, power-impact ramming, electric hammering, attaching an electric drill and/or a rotary-to-impact converter to the ramrod; placing a promotional message on the ramrod, and/or distributing the ramrod as a promotional item.

U.S. patent application Ser. No. 13/585,361, filed on Aug. 14, 2012, and Provisional Patent Application Ser. No. 61/772/049 filed on Mar. 4, 2013 are incorporated herein by reference thereto.

As defined herein, a plumbing tool is a plumbing ramrod plus something. That is the ramrod 10 of FIGS. 1 and 2, when combined with anything that identifies its use, even packaging, becomes a plumbing tool. In like manner, a ramrod plus any other useful part or detail, becomes a plumbing tool.

As defined herein, a ramrod that is elastically threaded through a discharge passageway is not subjected to stresses beyond the proportional limit of the material, whereas flexibly threading may result in the ramrod being bent somewhat. However, whether elastically threaded or flexibly threaded through a discharge passageway, all ramrods of the present invention include compressive flexibility and are therefore capable of impactly transmitting energy.

The method comprises elastically threading a ramrod through a discharge passageway, and preferably either bidirectional stiffening or unidirectional stiffening the ramrod. Stiffening comprises increasing a section modulus and may comprise changing a cross-sectional shape, using multiple layers, welding multiple layers, clamping multiple layers, folding material, attaching material, increasing material, adding a sleeve, and/or changing a cross-sectional shape. Unidirectional stiffening comprises changing a cross-sectional shape. Unidirectional stiffening in one direction plus manual stiffening in an opposite direction comprises bidirectional stiffening.

The method comprises ramming a ramrod, and the ramming step comprises impacting a blockage. The ramming step comprises manual ramming, slide hammering, or power impacting. Power impacting comprises auto hammering, applying rotary power, converting rotary power to impacts, attaching an electric drill to the ramrod, and interposing a rotary-to-impact converter between the electric drill and the ramrod.

The preferred embodiment for use as promotional merchandise is the unidirectionally stiffened plumbing tool 140 of FIGS. 13-16, with the flexible portion 142, the unidirectionally stiffened portion 144, and the bidirectionally-stiffened handle portion 192, because of its simplicity and economy.

Preferred embodiments for retail sales outlets are the plumbing tool 224 of FIGS. 26-29 for manual actuation, and 340 of FIG. 33 for power impact ramming.

The preferred embodiment for commercial use includes the ramrod 420 that is made of stacked spring steel ribbons of FIGS. 35-38, combined with the auto-hammer 292 of FIG. 31, because the stacked steel ribbons 402 bend through discharge passageways with minimum bending stress, have up to three or more times greater stiffness even through discharge passageways, and provide up to 27 times or even more stiffness where the ramrods are not required to make sharp bends and where additional stiffness is desirable or necessary to prevent buckling.

The preferred embodiment for home use is the power-impacting plumbing tool 340 of FIG. 33 because it is powerful, and because many homeowners already have a battery powered electric drill to power it, it is economical and has great sales potential.

While specific apparatus and method have been disclosed in the preceding description, it should be understood that these specifics have been given for the purpose of disclosing the principles of the present invention, and that many variations thereof will become apparent to those who are versed in the art.

What is claimed is:

1. A method which comprises:
a) flexibly threading a plumbing ramrod into a plumbing passageway proximal to a blockage;
b) ramming one end of said ramrod; and
c) impacting said blockage in response to said ramming step.

2. A method which comprises:
a) flexibly threading a plumbing ramrod into a curved discharge passageway of a toilet stool proximal to a blockage;
b) ramming one end of said ramrod; and
c) impacting said blockage in response to said ramming step.

3. The method claimed in claim 2 in which said method further comprises placing a promotional message on said plumbing ramrod.

4. The method claimed in claim 2 in which:
a) said ramming step comprises serpentinely storing energy; and
b) said impacting step comprises rippling said stored energy toward said blockage.

5. The method claimed in claim 2 in which said method comprises stiffening a longitudinal portion of said ramrod.

6. The method claimed in claim 2 in which said method further comprises unidirectionally stiffening a longitudinal portion of said ramrod.

7. The method claimed in claim 2 in which said method further comprises increasing a section modulus of said ramrod.

8. The method claimed in claim 2 in which said ramming step comprises slide hammering.

9. The method claimed in claim 2 in which said ramming step comprises power-impact ramming.

10. The method claimed in claim 2 in which said ramming step comprises converting rotary power into power-impact ramming.

11. The method claimed in claim 2 in which:
a) said ramming step comprises power-impact ramming; and
b) said ramming step comprises using a selective portion of a stroke of said power-impact ramming.

12. A plumbing tool which comprises:
an elongated plumbing ramrod with a first longitudinal portion that has elastic flexibility sufficient for threading into curved discharge passageways of toilet stools; and
means for stiffening a second longitudinal portion.

13. The plumbing tool claimed in claim 11 in which said means for stiffening comprises a unidirectionally-stiffened portion.

14. The plumbing tool claimed in claim 11 in which said means for stiffening comprises an increased section modulus.

15. The plumbing tool claimed in claim 11 in which said ramrod comprises a plurality of stacked ribbons.

16. The plumbing tool claimed in claim 11 in which said ramrod comprises a plurality of stacked ribbons; and said means for stiffening comprises means for restraining longitudinal movement between adjacent ones of said stacked ribbons.

17. The plumbing tool claimed in claim 11 in which said ramrod comprises a coiled spring.

18. The plumbing tool claimed in claim 11 in which said ramrod comprises a plastic extrusion.

19. The plumbing tool claimed in claim 11 in which said plumbing tool comprises a slide hammer.

20. The plumbing tool claimed in claim 11 in which said plumbing tool comprises a power-impact ramming device.

21. The plumbing tool claimed in claim 11 in which said plumbing tool comprises a rotary-to-impact converter.
